(19) United States
(12) Patent Application Publication
(10) Pub. No.: US 2010/0183395 A1
(43) Pub. Date: Jul. 22, 2010

(54) ORBITAL DRILLING TOOL UNIT

(75) Inventor: Stefan Mejerwall, Upplands Vasby (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: NOVATOR AB, SPANGA (SE)

(21) Appl. No.: 12/664,734

(22) PCT Filed: Jun. 17, 2008
(86) PCT No.: PCT/SE08/50719

§ 371 Date: Dec. 15, 2009

Related U.S. Application Data
(60) Provisional application No. 60/947,995, filed on Jul. 5, 2007.

(51) Int. Cl. B23B 43/00

(52) U.S. Cl. 409/191

(57) ABSTRACT

An orbital drilling tool unit configured to be detachably mounted to a rotatable spindle of a stationary machine tool. The tool unit comprises an outer eccentric body having an eccentric, longitudinally extending cylindrical hole, an inner eccentric body rotatably supported in the eccentric hole of the outer eccentric body and having likewise an eccentric, longitudinally extending cylindrical hole, a spindle motor for detachably supporting a cutting tool and rotatably supported in the eccentric hole of the inner eccentric body. The machine tool end of the outer eccentric body is configured to be concentrically mounted to a tool holder attached to the machine tool spindle for rotating the outer eccentric body. A radial offset adjusting means is configured for rotating the inner eccentric body relative to the outer eccentric body for adjusting the radial offset of the spindle motor center axis relative to the center axis of the machine tool spindle, and a means is provided for transferring power to the spindle motor for rotating the cutting tool.

### BACKGROUND OF THE INVENTION

The present invention relates to an orbital drilling tool unit configured to be detachably mounted to a rotatable spindle of a stationary machine tool according to the preamble of claim 1.

Portable or hand-hold orbital drilling machines are previously known (cf. eg. U.S. Pat. No. 6,382,890 B2), which include a fixed housing for a rotatable outer eccentric cylinder having an eccentric, longitudinally extending cylindrical hole, an inner eccentric cylinder rotatably supported in the eccentric hole of the outer cylinder and having likewise an eccentric, longitudinally extending cylindrical hole, and a spindle motor for detachably supporting a cutting tool and supported in the eccentric hole of the inner cylinder. Such portable orbital drilling machines are preferably used in the aircraft and space industries and are usually temporarily fixated to a drill template for drilling holes in workpieces of fiber-reinforced composite materials to which the template is attached. Owing to the orbital movement of the cutting tool during the hole-processing in such materials, a high quality of the hole walls is achieved. In order to execute rotation of the cutting tool, adjusting the radial offset thereof relative a principal (hole) axis by rotating the inner cylinder relative to the outer cylinder, orbiting the cutting tool by rotating the outer cylinder, and axially advancing the cutting tool into the workpiece up to four different motors or drive units may be needed.

Although some stationary machine tools, such as CNC machine tools, are able to provide a mutual orbital movement per se between a rotating cutting tool and a workpiece either by sliding a workpiece holder in coordinated x and y directions relative to a stationary machine tool spindle, or moving the tool spindle head in correspondingly coordinated x and y directions relative to a stationary workpiece, such stationary machine tools are not able to provide an orbital movement of just the spindle motor and the cutting tool like in the portable orbital drilling machines, but the whole workpiece holder or machine spindle head of the stationary machine tool need to be moved according to a system of coordinates by means of complex drive mechanisms.

### SUMMARY OF THE INVENTION

It is an object of the invention to provide an orbital drilling tool unit which is configured to be detachably mounted to a rotatable spindle of a stationary machine tool so that the latter can perform an orbital drilling operation in a workpiece without having to orbit the machine tool head or the workpiece holder. For this purpose the orbital drilling tool unit of the present invention is characterized by the features of claim 1. More particularly, the orbital drilling tool unit of the invention comprises an outer eccentric body having an eccentric, longitudinally extending cylindrical hole; an inner eccentric body rotatably supported in the eccentric hole of the outer eccentric body and having likewise an eccentric, longitudinally extending cylindrical hole; a spindle motor for detachably supporting a cutting tool and rotatably supported in the eccentric hole of the inner eccentric body; a tool holder concentrically attached to a machine tool end of the outer eccentric body for detachably mounting the latter to the machine tool spindle for rotation of the outer eccentric body together therewith; a radial offset adjusting means configured for rotating the inner eccentric body relative to the outer eccentric body for adjusting the radial offset of the spindle motor center axis (and the cutting tool axis) relative to the center axis of the machine tool spindle; and a means for transferring power to the spindle motor and the radial offset adjusting means. By using such an orbital drilling tool unit, when attached to the rotatable spindle of a stationary machine tool, orbital drilling/machining can easily be performed by the stationary machine tool without having to move the spindle head or workpiece holder thereof in x and y directions according to a system of coordinates.

In the orbital drilling tool unit of the invention the rotation of the cutting tool is generated by the spindle motor, whereas the orbital movement of the cutting tool is generated by directly rotating the outer eccentric body of the drilling tool unit by means of the spindle of the machine tool. The axial advance or feed of the cutting tool is performed by displacing the spindle head of the machine tool in the z direction.

Although, in a broadest aspect, the radial offset adjusting of the cutting tool could be made manually by turning a tangential screw between the housing and the inner cylinder, in a manner similar to what is disclosed in FIG. 3 of U.S. Pat. No. 6,382,890, the radial offset adjustment is preferably carried out by rotating the inner eccentric body relative to the outer eccentric body by means of a second motor which is attached to the rotatable outer eccentric body of the drilling tool unit and drivingly connected to the inner eccentric body e.g. by a belt transmission. This allows for varying the radial offset during the hole drilling process, e.g. for widening a hole or recess or for compensating a reduced diameter of the cutting tool due to wear of the cutting edges thereof.

The means for transferring power to the spindle motor for rotating the cutting tool and to the motor for adjusting the radial offset of the spindle motor preferably comprises a slip ring follower configured for engagement with concentric slip rings of a complementary swivel member to be stationary or non-rotatably attached to the machine tool. The swivel member may also include a fluid passage for supplying a fluid medium for cooling the spindle motor.

Further features and advantages of the drilling tool unit of the present invention will be disclosed more in detail with reference to the accompanying drawings.

### BRIEF DESCRIPTION OF THE DRAWINGS

FIG. 1 is a longitudinal section view of an orbital drilling tool unit of the invention;

FIG. 2 is a front perspective view of the orbital drilling tool unit in FIG. 1;

FIG. 3 is a rear perspective view of the orbital drilling tool unit in FIG. 1;

FIG. 4 is an end view of the orbital drilling tool unit in FIG. 1.

### DESCRIPTION OF A PREFERRED EMBODIMENT OF THE INVENTION

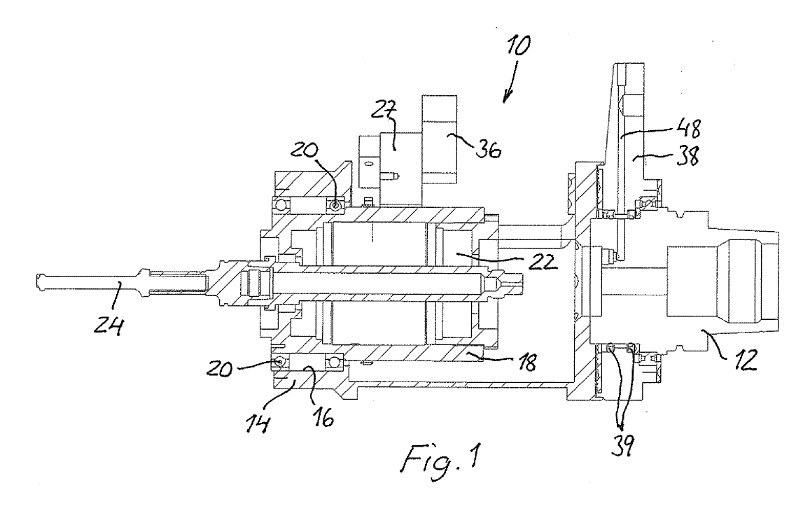

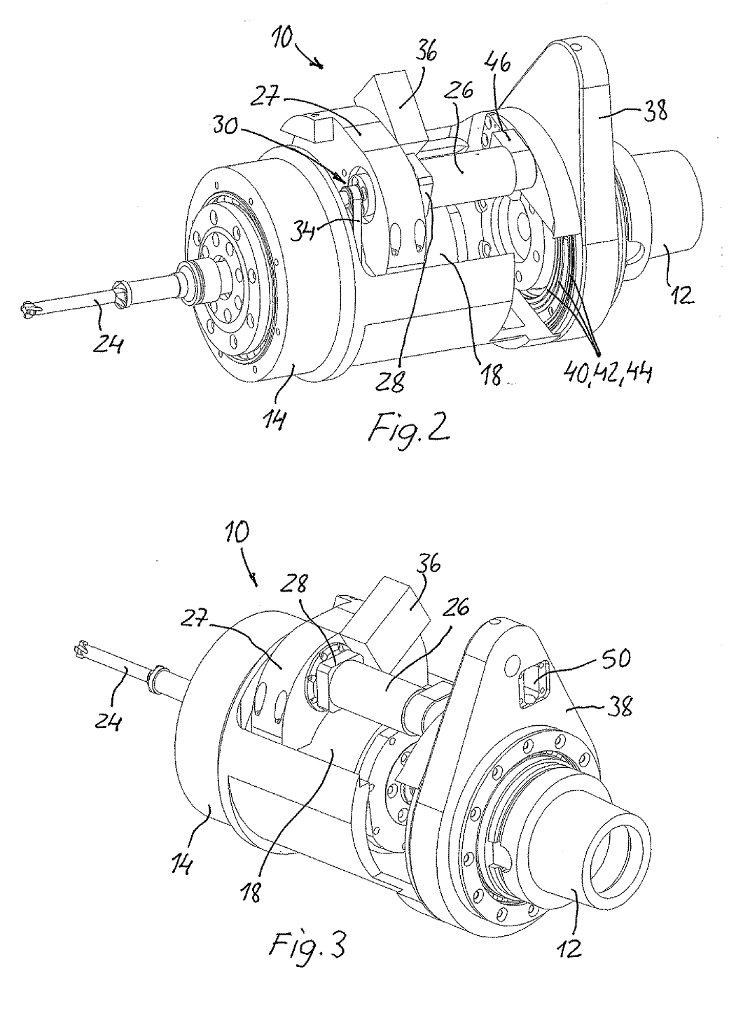

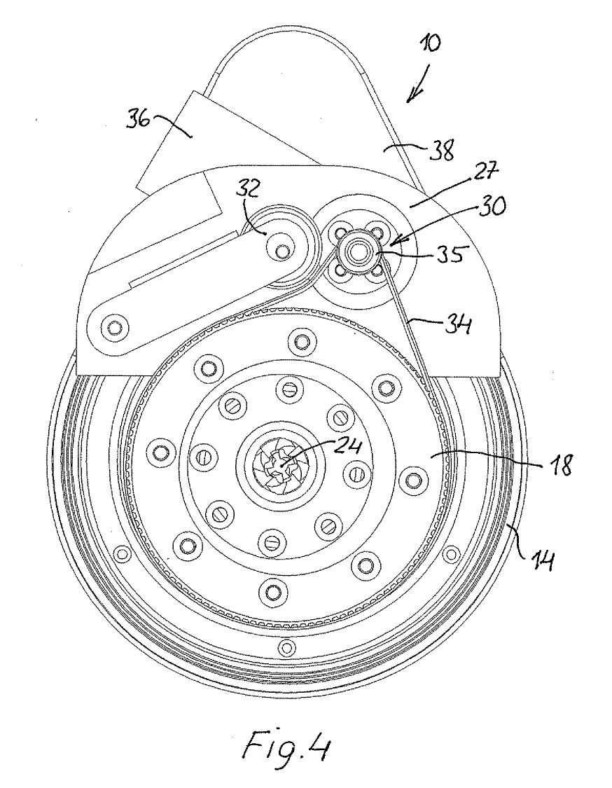

An orbital drilling tool unit 10 of the present invention includes 10 is configured to be exchangeably mounted to a rotatable spindle (output shaft) of a stationary machine tool, e.g. a CNC machine tool (not shown in the drawings) by means of an intermediate tool holder 12. The tool holder 12 may be of any suitable known type, such as a so called HSK, KM, Capto, or the like. FIG. 1 discloses a “HSK” tool holder 12.

The orbital drilling tool unit 10 comprises an outer eccentric body 14 which is mechanically connected to the tool holder 12 so as to be rotatable together therewith. Thus, as the machine tool spindle rotates, the outer eccentric body 14 and the tool holder 12 will rotate together with the same angular speed. The outer eccentric body 14 has an eccentric hole 16, in which an inner eccentric body 18 is rotatably mounted by means of a pair of bearings 20.

An electric (or possibly pneumatic) spindle motor 22, to which a cutting tool 24 is exchangeably attached, is mounted within an eccentric hole 25 of the inner eccentric body 18 and rotates the cutting tool 24 about its center axis.

An electric servo motor 26 is mounted to a bracket 27 attached to the outer eccentric body 14. The servo motor 26 is drivingly connected to the inner eccentric body 18 via a play-free gear box 28 and a belt drive 30. A belt tensioning member 32 (FIG. 4) engages a belt 34 to stretch it to a predetermined value. As the electric motor 26 is activated to rotate a belt wheel 35 associated therewith, the inner eccentric body 18 is rotated relatively to the outer eccentric body 14 by means of the belt 34, so that the radial offset—i.e. the distance between the center axis of the tool holder 12 and that of the cutting tool 24—may be varied or adjusted between a minimum (a zero value for ordinary drilling) and a maximum value. Thus, as the machine tool spindle rotates, the cutting tool 24 can rotate coaxially with (zero radial offset) or move in an eccentric or orbiting path relatively to the center axis of the tool holder 12 with a radial offset that is controlled by the electric motor 26 and the belt drive 30. Simultaneously with the orbiting motion, the spindle motor 22 rotates the cutting tool 24 about the center axis thereof, and the axial feed (z direction) of the cutting tool 24 is performed by the machine tool head so as to produce a hole, a recess, or any other slot or groove-like configuration in a workpiece.

The orbital drilling tool unit 10 further comprises a drive control unit 36 for the electric servo motor 26. The control unit 36 may be attached to the bracket 27 and contain relevant data memories, encoders, etc.

In use, in order to supply the motors 22 and 26 and the control unit 36 with electric power and relevant control signals, a swivel member 38, which encompasses an axial portion of the tool holder 12 and is supported thereof by two bearings 39, is held fixedly docked to the machine tool. The stationary swivel member 38 is provided with groups of slip rings 40, 42 and 44 which are engaged by corresponding contact elements (not shown) of a slip ring follower 46 attached to a housing of the rotary servo motor 26. Furthermore, the swivel member 38 has a fluid connection 48 for a pneumatic or liquid medium for cooling the spindle motor 22. Also, the swivel member 38 comprises an electric terminal 50 for transferring electric power and signals to the slip rings 40, 42, 44. The electric signals may be transferred through a bus connection, such as a “profibus”.

An external machine tool controller (not shown) is programmed to control the working process of the orbital drilling tool unit 10 to execute relevant drilling or cutting operations in a workpiece. Thus, with the orbital drilling tool unit 10 of the invention, the orbital rotary motion of the cutting tool 24 is performed by rotating the spindle of the machine tool, whereas the radial offset adjustment of the cutting tool relative to the center axis of the machine tool spindle (and tool holder 12) is performed by rotating the inner eccentric body 18 relative to the outer eccentric body 14 by means of the servo motor 26 and the belt drive 30. The axial feed of the cutting tool 24 is executed by axially displacing the machine tool spindle, i.e. the orbital drilling tool unit 10 as a whole.

Since the motor 26 for the radial offset adjustment of the cutting tool 24 rotates together with the outer eccentric body 14, relevant measures and steps for weight-balancing the rotating orbital drilling tool unit 10 have been taken.

Thus, the present invention provides an orbital drilling tool unit 10 which may be adapted to exchangeably fit various conventional machine tools by means of an intermediate tool holder interface. In contrast to conventional portable orbital drilling units, in which three or four motors are integrated in the tool unit, the orbital drilling tool unit of the invention includes only two motors, i.e. the spindle motor 22 and the radial offset adjustment motor 24.

1. An orbital drilling tool unit configured to be detachably mounted to a rotatable spindle of a stationary machine tool, wherein said unit comprising:
an outer eccentric body having an eccentric, longitudinally extending cylindrical hole;
an inner eccentric body rotatably supported in the eccentric hole of the outer eccentric body and having likewise an eccentric, longitudinally extending cylindrical hole;
a spindle motor for detachably supporting a cutting tool and rotatably supported in the eccentric hole of the inner eccentric body;
a tool holder concentrically attached to a machine tool end of the outer eccentric body for detachably mounting the latter to the machine tool spindle for rotation of the outer eccentric body together therewith;
a radial offset adjusting means configured for rotating the inner eccentric body relative to the outer eccentric body for adjusting the radial offset of the center axis of the spindle motor relative to the center axis of the machine tool spindle; and
a means for transferring power to the spindle motor and the radial offset adjustment means.

2. The orbital drilling tool unit of claim 1, wherein the radial offset adjusting means comprises an electrical motor fixedly attached to the outer eccentric body and drivingly connected to the inner eccentric body.

3. The orbital drilling tool unit of claim 2, wherein the electrical motor is drivingly connected to the inner eccentric body by means of a belt transmission.

4. The orbital drilling tool unit of claim 1, wherein the means for transferring power is configured to deliver electric power to the motor of the radial offset adjusting means.

5. The orbital drilling tool unit of claim 1, wherein the means for transferring power comprises a slip ring follower configured for engagement with concentric slip rings of a complementary swivel member configured to be stationary attached to the machine tool.

6. The orbital drilling tool unit of claim 5, wherein the swivel member includes a fluid passage for supplying a fluid medium for cooling the spindle motor.

7. The orbital drilling tool unit of claim 5 wherein the swivel member has a through-opening for rotatably receiving the tool holder therein.
